(19) United States
(12) Patent Application Publication
(10) Pub. No.: US 2025/0309996 A1
(43) Pub. Date: Oct. 2, 2025

(54) OPTICAL RECEIVER AND SIGNAL PROCESSING METHOD

(71) Applicant: Huawei Technologies Co., Ltd., Shenzhen (CN)

(72) Inventors: Zhiping Jiang, Kanata (CA); Zhuhong Zhang, Kanata (CA)

(21) Appl. No.: 18/492,878

(22) Filed: Oct. 24, 2023

(51) Int. Cl. H04B 10/69; H04B 10/61

(52) U.S. Cl. CPC H04B 10/6932; H04B 10/6164

(57) ABSTRACT

An optical receiver includes: a data processing circuit used to receive an optical signal carrying data information and perform a signal processing on the optical signal to obtain the data information and performance parameter(s) for indicating transmission quality of the optical signal; a memory used to dynamically buffer waveform data obtained through the signal processing of the optical signal; and a detection controller used to output a first indicating signal to the memory in a case where the at least one performance parameter satisfies a first condition. The first condition includes that the optical signal has a transmission fault and/or the transmission quality of the optical signal decreases to a first degree. The memory is further used to freeze current waveform data to obtain frozen waveform data in response to the first indicating signal, and the frozen waveform data includes waveform characteristic information of the transmission fault.

### TECHNICAL FIELD

The present application relates to the field of optical communication technologies, and in particular, to an optical receiver, and a signal processing method.

### BACKGROUND

In the optical communication technologies, optical receivers and optical transmitters are provided in different optical communication nodes. Between different optical communication nodes, service-related data information is carried on optical signals of different wavelengths through optical transmitters, and the optical signals are transmitted to optical receivers of other optical communication nodes through optical fibers. The optical receivers of these optical communication nodes will perform data processing on the received optical signals to parse service-related data information, thereby completing the service interaction of optical communication nodes.

### SUMMARY

Embodiments of the present disclosure provide an optical receiver, a signal processing method and a medium, which realize the capturing of waveform data corresponding to transient influence factors, and in turn realize the accurate classification, identification and localization of transmission faults.

In order to achieve the above purpose, the embodiments of the present disclosure adopt the following technique solutions.

In a first aspect, an optical receiver is provided. The optical receiver includes a data processing circuit, a memory and a detection controller. The data processing circuit is used to: receive an optical signal carrying data information and perform a signal processing on the optical signal to obtain the data information and at least one performance parameter, the at least one performance parameter being used to indicate a transmission quality of the optical signal. The memory is used to dynamically buffer waveform data that is obtained through the signal processing of the optical signal by the data processing circuit. The detection controller is used to output a first indicating signal to the memory in a case where the at least one performance parameter satisfies a first condition, and the first condition includes at least one of that the optical signal has a transmission fault or the transmission quality of the optical signal decreases to a first degree. The memory is further used to freeze current waveform data to obtain frozen waveform data in response to the first indicating signal, and the frozen waveform data includes waveform characteristic information of the transmission fault.

In the embodiments of the present disclosure, during the signal processing performed by the data processing circuit on the received optical signal, corresponding waveform data is generated. The memory dynamically buffers the waveform data. The at least one performance parameter includes parameter(s) related to the transmission quality of the optical signal. By determining whether the at least one performance parameter satisfies the first condition, it is determined whether the current waveform data that is dynamically buffered needs to be frozen to obtain frozen waveform data. The first condition includes at least one of that: the optical signal has a transmission fault, or the transmission quality of the optical signal decreases to the first degree. Therefore, when the at least one performance parameter satisfies the first condition, it means that the optical signal has a transmission fault at the current moment. Since the memory has dynamically buffered the waveform data for a period of time before the current moment, after the dynamically buffered waveform data is frozen, the waveform characteristic information corresponding to the transmission fault may be obtained from the frozen waveform data. In this way, the waveform data corresponding to transient influence factors may be obtained, thereby improving the feasibility and processing accuracy of operations such as capturing, classifying, identifying, and localizing the transmission faults.

In a possible implementation manner, the detection controller is further used to output a second indicating signal in a case where the at least one performance parameter satisfies a second condition, wherein the second condition includes that the transmission quality of the optical signal decreases to a second degree, and the transmission quality of the second degree is higher than the transmission quality of the first degree; and the memory is used to start dynamic buffering of the waveform data in response to the second indicating signal.

In the embodiments of the present disclosure, it is determined whether the at least one performance parameter satisfies the second condition. When the at least one performance parameter satisfies the second condition, it means that the transmission quality of the optical signal is decreasing and has decreased to the preset second degree. The second degree is a value preset according to actual situations. The second degree is determined according to the transmission quality that attention needs to be paid. There may be a moment when the transmission fault occurs. At this moment, the second indicating signal is generated, and the second indicating signal is used to indicate that the memory starts the dynamic buffering of the waveform data. Then, when the at least one performance parameter satisfies the first condition, the dynamically buffered waveform data can be frozen. Since the read and write operations of the memory will cause large power consumption, in the embodiments of the present disclosure, through the above operations, it may be possible to ensure the hit rate of freezing the waveform data while avoiding an increase in the power consumption due to prolonged dynamic buffering.

In a possible implementation manner, the detection controller is further used to: output alarm information according to the frozen waveform data; and the alarm information is used to indicate a type of the transmission fault and/or a location of the transmission fault.

In the embodiments of the present disclosure, for some types of transmission faults, when the detection controller of the optical receiver obtains the frozen waveform data, the frozen waveform data may be processed to output the alarm information to indicate the type of the transmission fault and/or the location of the transmission fault.

In a possible implementation manner, the detection controller is used to obtain the alarm information according to the frozen waveform data and state information; and the state information includes a transmission state parameter of the optical signal.

In the embodiments of the present disclosure, when the detection controller generates the alarm information based on the frozen waveform data, it may analyze the transmission fault based on both the frozen waveform data and state information that does not need to be dynamically captured by the memory. Similar to the at least one performance parameter, and the state information is also related to the transmission quality of the optical signal.

In a possible implementation manner, the state information includes at least one of: optical signal received power, bit error ratio (BER), bit error alarm information, signal-to-noise ratio (SNR), error vector magnitude (EVM), polarization dependent loss (PDL), differential group delay (DGD), state of polarization (SOP), signal spectrum, signal clock, fiber nonlinearity, local oscillator frequency offset (LOFO), carrier phase, automatic gain control (AGC) gain, device parameters of the data processing circuit, or carrier frequency.

In a possible implementation manner, the memory is used to sample the waveform data at intervals and dynamically buffer the sampled waveform data.

In the embodiments of the present disclosure, the size of the storage space of the memory affects the time span of the waveform data. In some scenarios, the duration of the waveform data that needs to be obtained is quite long. In order to store waveform data in a longer time span in a limited storage space, the waveform data may be sampled. In this case, the waveform data is sampled at intervals, and the sampled waveform data is dynamically buffered into the memory. In practical applications, there isn't much difference between adjacent waveform data. Therefore, the intervals may be set according to the characteristics of parameters of the waveform data that need to be used, so as to ensure that critical characteristic information is not lost while obtaining waveform data covering a time span as long as possible.

In a possible implementation manner, the memory is used to store time stamp information of the frozen waveform data.

In the embodiments of the present disclosure, although the optical receiver can record and process the at least one performance parameter, the generation time, duration and recording time of different performance parameters are different. In order to ensure the processing accuracy of the frozen waveform data, the time stamp information of the frozen waveform data may be stored in the memory. During the subsequent processing of the frozen waveform data, an accurate occurrence time of the corresponding frozen waveform data may be determined based on the time stamp information, thus improving the processing accuracy. When the frozen waveform data is sent offline to an external computing device for transmission fault analysis, the time stamp information may help the external computing device quickly and accurately determine the location of the transmission fault. When the detection controller analyses the transmission fault based on the frozen waveform data and the state information to output the alarm information, since the obtaining time and duration of the state information and the frozen waveform data are different, the state information and the frozen waveform data may be uniformly aligned in time through the time stamp information. In this way, it may be possible to achieve quick analysis and processing of the transmission faults in combination of the state information and the frozen waveform data.

In a possible implementation manner, the first condition includes at least one of a signal trigger condition, a static threshold condition, or a dynamic threshold condition.

In the embodiments of the present disclosure, the static threshold condition means that a certain static threshold may be set. When a performance parameter and the static threshold satisfies a certain relationship in size (for example, the performance parameter is greater than or equal to the static threshold), it is determined that the performance parameter satisfies the first condition. The static threshold may be set according to the relationship between the selected performance parameter and the transmission quality. The dynamic threshold condition means that a certain dynamic threshold may be set. When a performance parameter and the dynamic threshold satisfies a certain relationship in size (for example, the performance parameter is greater than or equal to the dynamic threshold), it is determined that the performance parameter satisfies the first condition. The dynamic threshold may be set according to the variation or rate of change of the corresponding performance parameter within unit time, or may be set according to the average and variation (or rate of change) of the corresponding performance parameter within unit time. The signal trigger condition means that some performance parameters are not values that change over time, but are represented as a state in which the performance parameters exist or a state in which the performance parameters do not exist. The presence or absence of these performance parameters is related to the transmission quality of the optical signal. In this case, by determining whether the performance parameter exists, a trigger signal corresponding to a performance parameter may be obtained; and the trigger signal is used as a trigger condition to instruct the memory to start dynamic buffering of the waveform data.

In a possible implementation manner, the at least one performance parameter includes at least one of: optical signal received power, BER, bit error alarm information, SNR, EVM, PDL, DGD, SOP, signal spectrum, signal clock, fiber nonlinearity, LOFO, carrier phase, AGC gain, device parameters of the data processing circuit, or carrier frequency.

In a possible implementation manner, the data processing circuit includes a coding correction circuit; the coding correction circuit is used to perform a coding error correction on the data information; and the detection controller is used to output the first indicating signal to the memory in a case where the coding error ratio or the coding error alarm information of the data information satisfies the first condition.

In the embodiments of the present disclosure, the coding correction circuit performs the coding error correction on the signal frame(s) in the data information. Whether the first condition is satisfied may be determined according to either the coding error ratio before the coding error correction or the coding error alarm information after the coding error correction.

In a possible implementation manner, a duration of the waveform data is greater than a duration of at least one signal frame.

In the embodiments of the present disclosure, the duration of the waveform data may be designed in consideration of the size of the storage space of the memory. When the duration of the waveform data is greater than the duration of at least one signal frame, the capacity of storing the relevant waveform data of the signal frame(s) may be ensured as much as possible. Therefore, when interleaving is adopted based on the frame timing, there may be a high burst error tolerance in the obtaining of the FEC BER.

In a second aspect, a signal processing method is provided. The signal processing method is performed by an optical receiver. The signal processing method includes: receiving an optical signal carrying data information; performing a signal processing on the optical signal to obtain the data information and at least one performance parameter, the at least one performance parameter being used to indicate a transmission quality of the optical signal; dynamically buffering waveform data that is obtained through the signal processing of the optical signal; generating a first indicating signal in a case where the at least one performance parameter satisfies a first condition, wherein the first condition includes at least one of that: the optical signal has a transmission fault or the transmission quality of the optical signal decreases to a first degree; and freezing current waveform data to obtain frozen waveform data in response to the first indicating signal, wherein the frozen waveform data includes waveform characteristic information of the transmission fault.

In a possible implementation manner, the signal processing method further includes generating a second indicating signal in a case where the at least one performance parameter satisfies a second condition. The second condition includes that the transmission quality of the optical signal decreases to a second degree, and the transmission quality of the second degree is higher than the transmission quality of the first degree; and the second indicating signal is used to indicate start of dynamic buffering of the waveform data.

In a possible implementation manner, the signal processing method further includes outputting alarm information according to the frozen waveform data; and the alarm information is used to indicate a type of the transmission fault and/or a location of the transmission fault.

In a possible implementation manner, outputting the alarm information according to the frozen waveform data includes: outputting the alarm information according to the frozen waveform data and state information, wherein the state information includes a transmission state parameter of the optical signal.

In a possible implementation manner, dynamically buffering the waveform data that is obtained through the signal processing of the optical signal includes: sampling the waveform data at intervals, and dynamically buffering sampled waveform data.

In a possible implementation manner, dynamically buffering the waveform data that is obtained through the signal processing of the optical signal includes storing time stamp information of the frozen waveform data.

In a possible implementation manner, the at least one performance parameter includes at least one of: optical signal received power, BER, bit error alarm information, SNR, EVM, PDL, DGD, SOP, signal spectrum, signal clock, fiber nonlinearity, LOFO, carrier phase, AGC gain, device parameters of a data processing circuit of the optical receiver, or carrier frequency.

In a possible implementation manner, generating the first indicating signal includes: performing a coding error correction on the data information; and generating the first indicating signal in a case where the coding error ratio or the coding error alarm information of the data information satisfies the first condition.

In a third aspect, a non-transitory computer-readable storage medium is provided. The non-transitory computer-readable storage medium has stored thereon computer program instructions that, when executed by a computer, cause the computer to perform the signal processing method as described in the second aspect.

As for technique principles and beneficial effects of the second aspect and the third aspect, reference can be made to the description of the first aspect, and details will not be repeated here.

### BRIEF DESCRIPTION OF THE DRAWINGS

FIG. 1 is a structural diagram of an optical communication system, in accordance with some embodiments of the present disclosure;

FIG. 2 is a structural diagram of an optical communication node, in accordance with some embodiments of the present disclosure;

FIG. 3 is a structural diagram of a first optical communication node and a second optical communication node, in accordance with some embodiments of the present disclosure;

FIG. 4 is a waveform diagram of a fast state of polarization (SOP) change, in accordance with some embodiments of the present disclosure;

FIG. 5 is a structural diagram of an optical receiver, in accordance with some embodiments of the present disclosure;

FIG. 6 is a schematic diagram showing a process of sampling waveform data at intervals, in accordance with some embodiments of the present disclosure;

FIG. 7 is a schematic diagram showing change of a dynamic threshold of a performance parameter, in accordance with some embodiments of the present disclosure;

FIG. 8 is a schematic diagram showing a processing of triggering waveform data freezing, in accordance with some embodiments of the present disclosure;

FIG. 9 is a diagram showing a waveform of triggering waveform data freezing in a case where a performance parameter is lower than a threshold, in accordance with some embodiments of the present disclosure;

FIG. 10 is a structural diagram of another optical receiver, in accordance with some embodiments of the present disclosure;

FIG. 11 is a schematic diagram showing waveform data buffering and waveform data freezing based on forward error correction (FEC) bit error ratio (BER), in accordance with some embodiments of the present disclosure;

FIG. 12 is a flow diagram of a signal processing method, in accordance with some embodiments of the present disclosure;

FIG. 13 is a flow diagram of another signal processing method, in accordance with some embodiments of the present disclosure; and

FIG. 14 is a flow diagram of yet another signal processing method, in accordance with some embodiments of the present disclosure.

### DETAILED DESCRIPTION

Technical solutions in some embodiments of the present disclosure will be described clearly and completely with reference to the accompanying drawings below. However, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as open and inclusive meaning, i.e., “including, but not limited to”. In the description, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms “first” and “second” are used for descriptive purposes only, and are not to be construed as indicating or implying the relative importance or implicitly indicating the number of indicated technical features. Therefore, features defined with “first” and “second” may explicitly or implicitly include one or more of the features. In the description of the embodiments of the present disclosure, the term “multiple”, “a plurality of” or “the plurality of” means two or more unless otherwise specified.

In the description of some embodiments, the term “coupled” and “connected” and their derivatives may be used. For example, the term “connected” may be used when describing some embodiments to indicate that two or more components are in direct physical contact or electrical contact with each other. As another example, the term “coupled” may be used when describing some embodiments to indicate that two or more components are in direct physical contact or electrical contact with each other. However, the term “coupled” or “communicatively coupled” may also mean that two or more components are not in direct contact with each other but still cooperate or interact with each other. The embodiments disclosed herein are not necessarily limited to the content herein.

The phrase “at least one of A, B, and C” has a same meaning as the phrase “at least one of A, B, or C”, and both include the following combinations of A, B, and C: only A, only B, only C, a combination of A and B, a combination of A and C, a combination of B and C, and a combination of A, B, and C.

The phrase “A and/or B” includes the following three combinations: only A, only B, and a combination of A and B.

As used herein, the term “if” is, optionally, construed as “when”, “in a case where”, “in response to determining” or “in response to detecting”, depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

The use of the phrase “used to” or “configured to” herein means an open and inclusive language, which does not exclude devices that are used to or configured to perform additional tasks or steps.

In addition, the phrase “based on” used herein has an open and inclusive meaning, since a process, step, calculation or other action that is “based on” one or more of the stated conditions or values may, in practice, be based on additional conditions or values exceeding those stated.

During the service interaction process of optical communication nodes, in order to ensure the normal transmission of optical signals, there may be many devices for assisting optical communication between different optical communication nodes and within the corresponding optical communication nodes. Therefore, in the optical communication process, many devices will affect the transmission quality of the optical communication. Moreover, the physical distance between optical communication nodes is long, and interconnecting optical fibers are also very long. Fiber transmission faults or transmission performance will also greatly affect the transmission quality of the optical communication. Therefore, various transmission faults often occur during the transmission process of the optical communication. If the transmission faults cannot be quickly and accurately identified and localized, the transmission faults cannot be debugged and avoided timely, which will greatly affect the quality of the optical communication.

In actual applications, many transmission faults are caused by transient influence factors. The transient influence factors are difficult to capture but appear frequently. Since the relevant fault waveform characteristics of the transmission faults under the transient influence factors cannot be captured, the transmission quality of the optical communication is greatly affected.

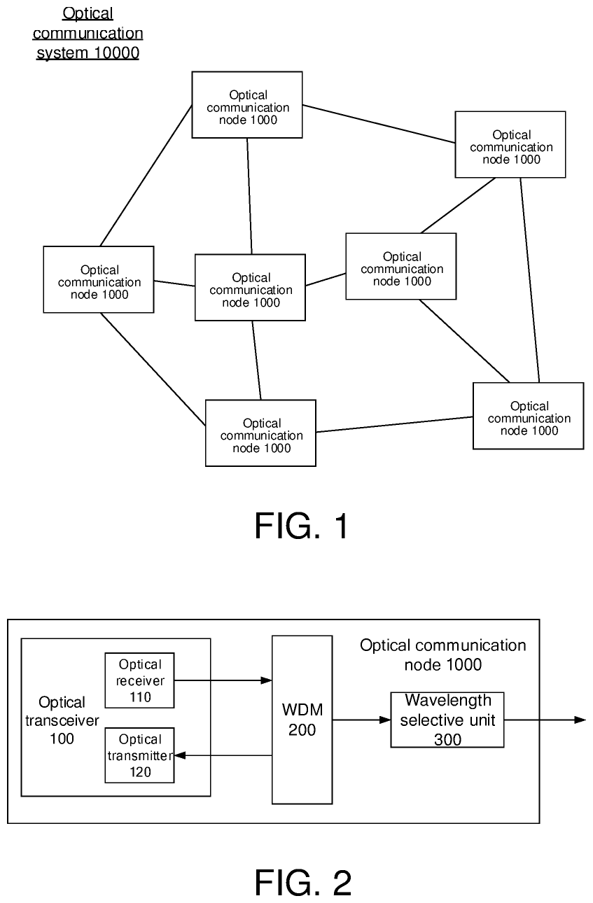

Some embodiments of the present disclosure provides a communication system. As shown in FIG. 1, the communication system 10000 includes a plurality of optical communication nodes 1000. Each optical communication node 1000 may interact with one or more other optical communication nodes 1000 in services. As shown in FIG. 2, the optical communication node 1000 includes an optical transceiver 100, a wavelength division multiplexer (WDM) 200 and a wavelength selective unit 300. The optical transceiver 100 may receive optical signals of different wavelengths from the WDM 200 or transmit optical signals of different wavelengths to the WDM 200. Optical signals of different wavelengths carry different service information. The wavelength selection unit 300 is used to add, drop or route optical signal channels of different wavelengths. For example, the functions of the wavelength selective unit 300 may be implemented through various devices, such as a multi/demultiplexer, an optical filter, or a wavelength selective switch (WSS). The optical transceiver 100 includes an optical receiver 110 and an optical transmitter 120. The optical receiver 110 is used to process a received optical signal to obtain data information. The optical transmitter 120 is used to modulate the data information onto an optical signal, and then send the optical signal carrying the data information to other optical communication nodes 1000. Each optical communication node 1000 may exchange optical signals (e.g., send optical signals and receive optical signals) with other optical communication nodes 1000 based on the WDM 200, the wavelength selective unit 300 and the optical transceiver 100, so as to realize service interaction. For example, the optical receiver 110 and the optical transmitter 120 may be coupled to the same WDM 200 in the optical communication node 1000 to which they belong, or may be coupled to different WDMs 200 in the optical communication node 1000 to which they belong.

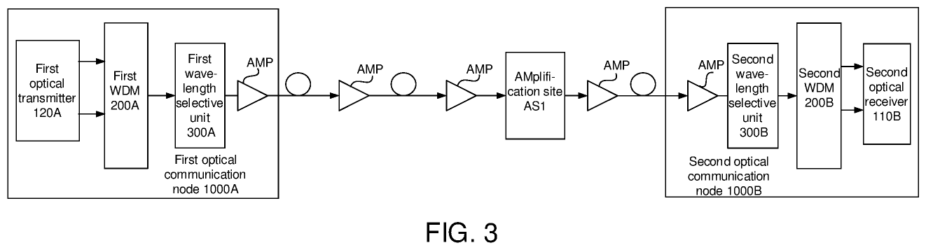

For example, as shown in FIG. 3, the first optical communication node 1000A sends service to the second optical communication node 1000B. The first optical transmitter 120A of the first optical communication node 1000A modulate data information onto optical signals of different wavelengths, and transmits the optical signals of different wavelengths through the first wavelength selective unit 300A and the first WDM 200A to the optical fiber. The optical fiber transmits the optical signals of different wavelengths to the second optical communication node 1000B. The second wavelength selective unit 300B of the second optical communication node 1000B transmits an optical signal of a specific wavelength to the second WDM 200B and then transmits it to the second optical receiver 110B through the second WDM 200B. After the second optical receiver 110B receives the optical signal and processes the received optical signal, the second optical receiver 110B converts the received optical signal into electrical signals through a photoelectric conversion module, and obtains corresponding data information from the electrical signals. Thus, the service is received. In some examples, as shown in FIG. 3, one or more amplification sites AS1 may be provided between the first optical communication node 1000A and the second optical communication node 1000B. In the amplification site AS1, channel-adding and/or channel-dropping processing of the optical signal may be realized through a wavelength selective unit. In this case, since the transmission distance between the first optical communication node 1000A and the second optical communication node 1000B is long, in order to ensure the transmission quality of the optical signal, as shown in FIG. 3, the optical communication node 1000, the amplification site AS1 or the optical fiber may be provided therein with optical amplifier(s) AMP. The optical amplifier(s) AMP may increase the optical power of the optical signal to ensure the long-distance transmission of the optical signal. For example, the optical amplifier AMP may be an erbium doped fiber amplifier (EDFA).

In some possible implementation manners, the communication system 10000 may be an optical communication system, or a meshed network system.

In the optical communication process, since the communication system 10000 is very complicated and distributed over a wide range of physical space, many factors will affect the quality of the optical communication during the service interaction process, and even cause the transmission faults of the optical communication. The transmission faults include, but are not limited to, the situations described below.

In situation 1, the optical amplifier(s) AMP may inevitably introduce the amplifier spontaneous emission (ASE) noise during the power amplification process of the optical signal, thereby increasing the optical signal-to-noise ratio (OSNR) of the optical signal. When the OSNR is below a certain value, the communication failure will occur.

In situation 2, different influence factors cause bending or cut of the optical fiber that transmits optical signals, resulting in fiber loss change.

In situation 3, the Kerr nonlinearity of the optical fiber causes the nonlinear distortion or nonlinear noise to optical signal parameters.

In situation 4, when the wavelength selective unit 300 is the WSS, the WSS processes the optical signals of different wavelengths based on optical filtering. The optical filtering process may reduce the signal spectrum of the optical signal, resulting in inter-symbol interference (ISI).

In situation 5, polarization effects (such as polarization dependent loss, polarization mode dispersion, state of polarization change, etc.) during the optical signal transmission may also affect the transmission quality of the optical signals.

In situation 6, when the wavelength selective unit 300 (e.g., the WSS) adds or drops different wavelength channels, the optical power of the transmitted optical signal will change to cause the change of the amplification gain of the optical amplifier AMP, thus affecting the transmission quality.

In situation 7, when the optical fiber transmits the optical signals, the stimulated Raman scattering (SRS) effect will occur, thus affecting the transmission quality.

In situation 8, multi-path interference (MPI) caused by reflected signals or backscattered signals generated during the optical transmission will also reduce the transmission quality.

In situation 9, the device degradation of the optical transceiver 100 will also reduce the transmission quality.

In situation 10, some equipment operations or performance optimization operations during the optical transmission process will also affect the transmission quality.

It should be noted that, in addition to the above situations, there are some other situations that affect the transmission quality, which will not be provided here.

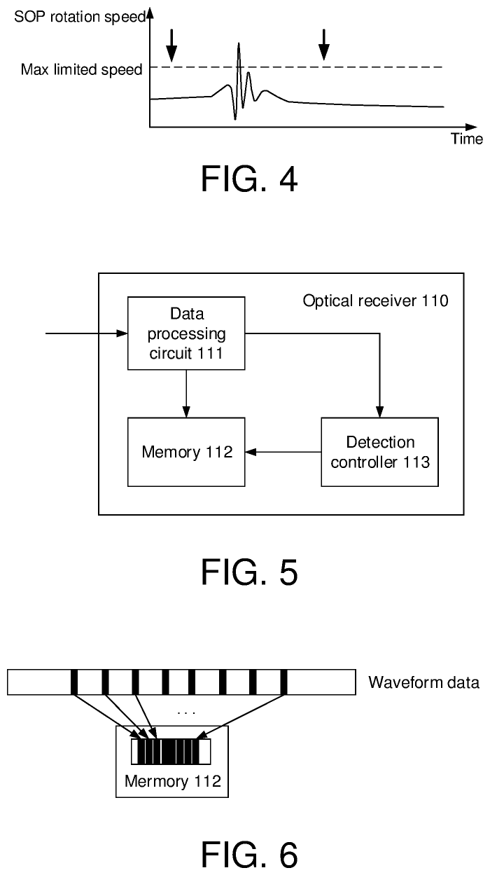

The above situations are only some simple examples where the transmission quality of the optical signals is affected. In practical applications, there are numerous factors that can affect the degradation of the transmission quality of the optical signals. The communication system 10000 based on the optical signals involves many devices, and the communication distribution range is very wide. The transmission faults need to be detected and located timely to achieve debugging as quickly as possible, so as to improve communication efficiency and communication quality as much as possible. However, in actual applications, the transmission faults may occur at the software level or at the hardware level. Some transmission faults can be detected easily, and they can be classified, identified and located very easily. Some transmission faults are difficult to detect, classify, or locate. For example, some intermittent transmission faults will cause traffic interruption for short period of time. The faults may be reported within a period in which the traffic interruption lasts from less than second to minutes, but it may take days or even months to find root causes of the transmission faults. There are many types of transmission faults, some transmission faults are persistent and will cause long-lasting traffic interruption, which can only be solved with intervention; and some transmission faults are short, cause intermittent traffic interruption, and may disappear without intervention. The short-term transient faults with short duration are usually difficult to capture, and it is relatively hard to achieve classification and/or localization analysis of the transmission faults without obtaining data information related to the transmission faults. For example, as shown in FIG. 4, the fast state of polarization (SOP) change of the optical signal is monitored, and the optical receiver 110 can track fast SOP change under the max limited speed. When the fast SOP change exceeds the max limited speed, the traffic interruption will occur. The duration of fast SOP change is very short. Therefore, when the optical receiver 110 detects the SOP based on a certain detection period, the traffic interruption will occur after the SOP change exceeds the max limited speed. Since the SOP change exceeds the max limited speed for a very short duration, the abnormal fast SOP change is missed in two detection periods. It should be noted that in FIG. 4, the waveform where the fast SOP change exceeds the max limited speed is enlarged, and the actual time occupied by the abnormal fast SOP change is much smaller than the time scale shown in FIG. 4. Therefore, when some transmission faults occur, they may be caused by influence factors corresponding to some waveform data that are difficult to obtain instantaneously. If the waveform data corresponding to the transient influence factors cannot be obtained in time, it will be difficult to identify, classify and localize the transmission faults.

In order to obtain waveform data corresponding to transient influence factors and achieve more accurate classification, detection and localization of the transmission faults, the embodiments of the present disclosure provide an optical receiver 110, and as shown in FIG. 5, the optical receiver 110 includes a data processing circuit 111, a memory 112 and a detection controller 113. The data processing circuit 111 is used to receive an optical signal carrying data information and perform signal processing on the optical signal to obtain the data information and at least one performance parameter. The at least one performance parameter is used to indicate the transmission quality of the optical signal. The memory 112 is used to dynamically buffer waveform data that is obtained through the signal processing of the optical signal by the data processing circuit 111. The detection controller 113 is configured to output a first indication signal to the memory 112 in a case where the at least one performance parameter satisfies a first condition. The first condition includes at least one of the following that: the optical signal has a transmission fault, or the transmission quality of the optical signal decreases to a first degree. The memory 112 is further used to freeze current waveform data in response to the first indicating signal to obtain frozen waveform data; and the frozen waveform data includes waveform characteristic information of the transmission fault. For example, the transmission quality of the optical signal decreases to the first degree includes the transmission quality of the optical signal decreases to the first degree or below.

In the embodiments of the present disclosure, as shown in FIG. 5, during the signal processing performed by the data processing circuit 111 on the received optical signal, the corresponding waveform data is obtained. The memory 112 dynamically buffers the waveform data. The at least one performance parameter includes parameter(s) related to the transmission quality of the optical signal. By determining whether the at least one performance parameter satisfies the first condition, it is determined whether the current waveform data that is dynamically buffered needs to be frozen to obtain frozen waveform data. The first condition includes at least one of that: the optical signal has a transmission fault, or the transmission quality of the optical signal decreases to the first degree. Therefore, when the at least one performance parameter satisfies the first condition, it means that the optical signal has a transmission fault at the current moment. Since the memory 112 has dynamically buffered the waveform data for a period of time before the current moment, after the dynamically buffered waveform data is frozen, the waveform characteristic information corresponding to the transmission fault may be obtained from the frozen waveform data. In this way, the waveform data corresponding to transient influence factors may be obtained, thereby improving the feasibility and processing accuracy of operations such as capturing, classifying, identifying, and localizing the transmission faults.

In some possible implementation manners, in the actual application of the optical communication, the performance of the optical communication will be detected in many manners. In some examples, the optical power of the optical signal may be detected by a photodetector (PD) in the transmission link of the optical signal. In some examples, the optical signal may be detected by an optical detection device other than the optical receiver 110. For example, the optical signal is monitored by an optical supervisory channel (OSC). In some examples, the channel power of the optical signal and the amplitude modulation pilot tone of the associated channel information may be detected. In some examples, a miniature optical spectrum analyzer may be used to monitor the spectrum of the optical signal. In some examples, some functional units or devices for detecting various performance parameters may be integrated into the optical transceiver 100. In some examples, some temperature sensors may be provided to detect the temperature states of all devices in the optical communication. In some examples, the detection and capturing of various performance parameters may be performed by the data processing circuit 111 in the optical receiver 110 or a related data processing device in the optical receiver 110. In some examples, an optical time domain reflectometer (OTDR) may be provided to detect fiber insertion loss and signal reflection. In some examples, in addition to the above examples, other manners may also be used to detect one or more performance parameters in the optical communication. The embodiments of the present disclosure may use one or more performance parameters obtained in the above manners as reference parameters for determining the first condition, thus achieving the obtaining of the frozen waveform data.

For example, the at least one performance parameter includes at least one of: optical signal received power, bit error ratio (BER), bit error alarm information, signal-to-noise ratio (SNR), error vector magnitude (EVM), polarization dependent loss (PDL), differential group delay (DGD), state of polarization (SOP), signal spectrum, signal clock, fiber nonlinearity, local oscillator frequency offset (LOFO), carrier phase, automatic gain control (AGC) gain, device parameters of the data processing circuit 111, or carrier frequency. The at least one performance parameter may further include other parameters in addition to the parameters in the above example.

In some possible implementation manners, the memory 112 may be a ring memory or a cyclic memory. The waveform data is dynamically buffered through the memory 112 in a first-in-first-out (FIFO) manner. In the embodiments of the present disclosure, the storage space of the memory 112 is limited. In the limited storage space, waveform data that is stored first is cleared first. In this way, the purpose of dynamically buffering the waveform data in real time within a period of time may be achieved. The size of the storage space of the memory 112 affects the time span of the waveform data.

In some possible implementation manners, the memory 112 is used to sample the waveform data at intervals and dynamically buffer sampled waveform data. In the embodiments of the present disclosure, the size of the storage space of the memory affects the time span of the waveform data. Therefore, in some scenarios, the duration of the waveform data that needs to be obtained is quite long. Therefore, in order to store waveform data in a longer time span in a limited storage space, the waveform data may be sampled. As shown in FIG. 6, the waveform data is sampled at intervals, and the sampled waveform data is dynamically buffered into the memory 112. In practical applications, there isn't much difference between adjacent waveform data. Therefore, the intervals may be set according to the characteristics of parameters of the waveform data that need to be used, so as to ensure that critical characteristic information is not lost while obtaining waveform data covering a time span as long as possible.

In some possible implementation manners, the memory 112 may be configured to enable continuous dynamic buffering in response to a start-up operation. In the embodiments of the present disclosure, since the memory 112 performs dynamic buffering for a long time, the operation of freezing waveform data may be performed timely in a case where any of the at least one performance parameter satisfies the first condition.

In some possible implementation manners, the memory 112 may be configured to enable dynamic buffering in response to a certain trigger condition. For example, the memory 112 is triggered by a certain trigger signal to start to dynamically buffer the waveform data.

For example, the detection controller 113 is further configured to output a second indicating signal to the memory 112 in a case where the at least one performance parameter satisfies a second condition. The second condition includes the transmission quality of the optical signal decreases to a second degree. The second degree is greater than the first degree. That is, the transmission quality of the optical signal of the second degree is higher than the transmission quality of the optical signal of the first degree. The memory 112 is used to start dynamic buffering of the waveform data in response to the second indicating signal. In the embodiments of the present disclosure, it is determined whether the at least one performance parameter satisfies the second condition. When the at least one performance parameter satisfies the second condition, it means that the transmission quality of the optical signal is decreasing and decreases to the preset second degree or below. The second degree is a value preset according to the actual situations. The second degree is determined according to the transmission quality that attention needs to be paid. There may be a moment when the transmission fault occurs. At this moment, the second indicating signal is generated, and the second indicating signal is used to indicate that the memory 112 starts the dynamic buffering of the waveform data. Then, when the at least one performance parameter satisfies the first condition, the dynamically buffered waveform data can be frozen. Since the read and write operations of the memory 112 will cause large power consumption, in the embodiments of the present disclosure, through the above operations, it may be possible to ensure the hit rate of freezing the waveform data while avoiding an increase in the power consumption due to prolonged dynamic buffering.

For example, the detection controller 113 is further configured to output a third indicating signal to the memory 112 in a case where the at least one performance parameter satisfies a third condition; and the third condition includes that the transmission quality of the optical signal increases to a third degree. The third degree is greater than the second degree. That is, the transmission quality of the optical signal of the third degree is higher than the transmission quality of the optical signal of the second degree. The memory 112 is further configured to stop dynamically buffering the waveform data in response to the third indicating signal. In the embodiments of the present disclosure, after the memory 112 starts to perform the dynamic buffering operation in response to the second indicating signal, if the at least one performance parameter does not satisfy the first condition in a subsequent period of time, and the at least one performance parameter satisfies a third condition, it means that the transmission quality increases, the transmission quality at this time is good, and there is no need to perform the operation of dynamically buffering the waveform data. In this case, the operation of dynamically buffering waveform data may be stopped to reduce the power consumption of the memory 112.

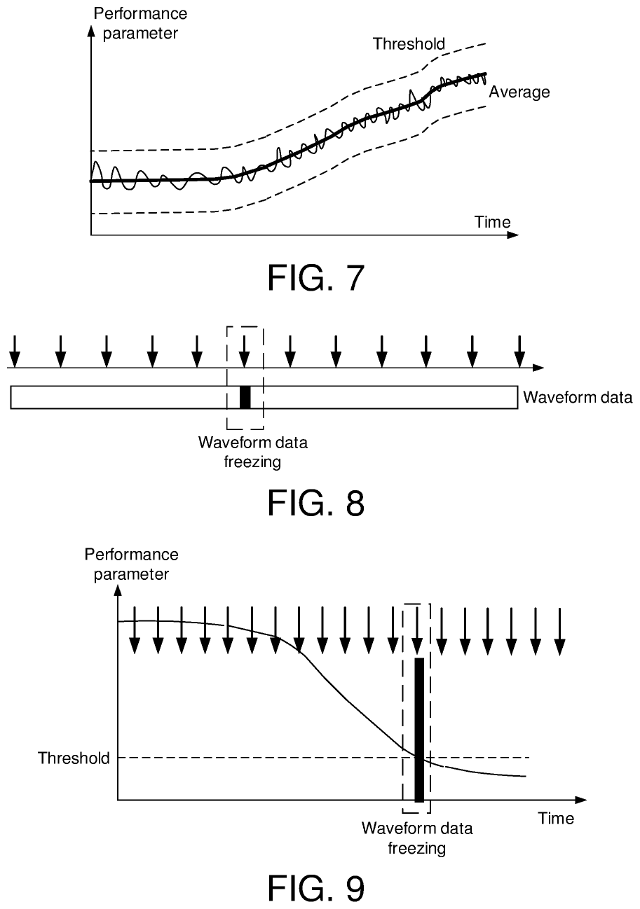

In some possible implementation manners, the first condition includes at least one of a signal trigger condition, a static threshold condition, or a dynamic threshold condition. In some examples, the static threshold condition means that a certain static threshold may be set. When a performance parameter and the static threshold satisfies a certain relationship in size (for example, the performance parameter is greater than or equal to the static threshold), it is determined that the performance parameter satisfies the first condition. The static threshold may be set according to the relationship between the selected performance parameter and the transmission quality. In some examples, the dynamic threshold condition means that a certain dynamic threshold may be set. When a performance parameter and the dynamic threshold satisfies a certain relationship in size (for example, the performance parameter is greater than or equal to the dynamic threshold), it is determined that the performance parameter satisfies the first condition. The dynamic threshold may be set according to the variation or rate of change of the corresponding performance parameter within unit time, or may be set according to the average and variation (or rate of change) of the corresponding performance parameter within unit time. For example, as shown in FIG. 7, the average of a certain performance parameter is obtained according to values of the performance parameter within a period of time, and the dynamic threshold of dynamic change of the performance parameter is obtained based on the average and the rate of change of the performance parameter. In some examples, the signal trigger condition means that some performance parameters are not values that change over time, but are represented as a state in which the performance parameters exist or a state in which the performance parameters do not exist. The presence or absence of these performance parameters is related to the transmission quality of the optical signal. In this case, by determining whether the performance parameter exists, a trigger signal corresponding to a performance parameter may be obtained; and the trigger signal is used as a trigger condition to instruct the memory 112 to start dynamic buffering of the waveform data.

For example, the first condition may be determined through one or more combinations of the signal trigger condition, the static threshold condition, and the dynamic threshold condition. For example, in a case where the transmission fault is abnormal fiber loss, when the fiber loss suddenly increases, the optical power of the optical signal transmitted by the optical receiver 110 may or may not change. For example, in some cases, the optical amplifiers APM compensate for the increased transmission loss. However, the optical amplifiers APM add more ASE noise to the optical signal, and the optical power of the optical signal is increased, resulting in the decrease in the OSNR of the optical signal. When the optical signal reaches the optical receiver 110, its optical power does not change significantly, but the quality of the optical signal received by the optical receiver 110 may be severely degraded, leading to significantly increased pre-FEC BER or significantly decreased SNR of the optical signal or even post-FEC alarm. The pre-FEC BER, SNR and post-FEC alarm information are used as performance parameters. When each of the pre-FEC BER and SNR crosses a respective threshold, or the post-FEC alarm occurs, it is determined that the at least one performance parameter satisfies the first condition. The first indicating signal is generated to trigger the freezing of the waveform data. As another example, when the fast SOP fails, if the SOP rotation exceeds the data tracking capability of the optical receiver 110, the post-FEC alarm will be caused. Once the post-FEC alarm occurs, the associated waveform data may be frozen. With the saved frozen waveform data, the SOP rotation speed may be analyzed offline to identify the root cause. Even if the post-FEC alarm is not generated, if the SOP rotation speed or pre-FEC BER exceeds the threshold, the frozen waveform data may help to understand the cause of the degraded performance.

For example, as shown in FIG. 8, the at least one performance parameter is detected repeatedly within a period of time. The arrows in FIG. 8 represent detection operations on the at least one performance parameter. When the at least one performance parameter obtained by one certain detection operation satisfies the first condition, the operation of freezing the waveform data may be triggered. As shown in FIG. 9, considering an example in which a certain performance parameter decreases as the transmission quality decreases, when the performance parameter decreases to a certain threshold, it is determined that the performance parameter satisfies the first condition. In this case, the first indicating signal may be generated to trigger the freezing of the waveform data.

In some possible implementation manners, the second condition and the third condition may each include at least one of the signal trigger condition, the static threshold condition, or the dynamic threshold condition. As for the working principles of the second condition and the third condition, reference may be made to the above relevant description of the first condition, and details will not be repeated here.

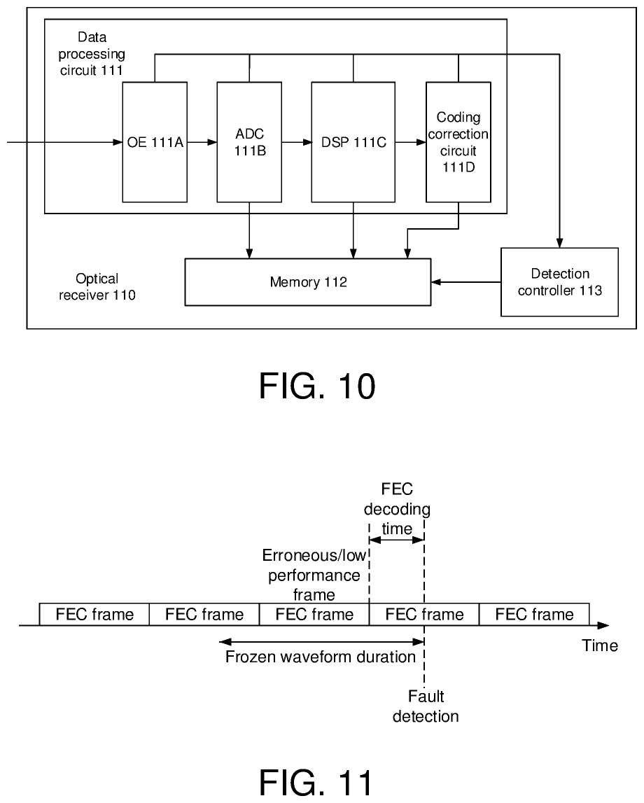

In some possible implementation manners, as shown in FIG. 10, the data processing circuit 111 includes an optical-electric front end (OE) 111A, an analog-to-digital converter (ADC) 111B, a digital signal Processor (DSP) 111C and a coding correction circuit 111D. The OE 111A is used to convert the optical signal received by the optical receiver 110 into electrical signals in the form of analog signals. The ADC 111B is used to convert the electrical signals in the form of analog signals into electrical signals in the form of digital signals. The DSP 111C is used to process electrical signals in the form of digital signals to obtain transmitted data information. The coding correction circuit 111D is used to correct coding errors of the data information. In some examples, one or more of the OE 111A, the ADC 111B, the DSP 111C, and the coding correction circuit 111D may provide performance parameter(s) to the detection controller 113, so as to obtain the at least one performance parameter. In some examples, in addition to the optical receiver 110, other devices may also provide parameter(s) to the detection controller 113 of the optical receiver 110 as the at least one performance parameter.

For example, as shown in FIG. 10, data obtained through the data processing by one or more of the ADC 111B, the DSP 111C and the coding correction circuit 111D may be dynamically buffered into the memory 112 as the waveform data.

In some possible implementation manners, the frozen waveform data in the memory 112 may be output to an external computing device. The external computing device uses corresponding algorithms to detect, classify, and localize the transmission fault based on the frozen waveform data.

In some possible implementation manners, the transmission fault may be detected and localized by the optical receiver 110. For example, the detection controller 113 is further configured to output alarm information according to the frozen waveform data; the alarm information is used to indicate a type of the transmission fault and/or a location of the transmission fault. In the embodiments of the present disclosure, for some types of transmission faults, when the detection controller 113 of the optical receiver 110 obtains the frozen waveform data, the frozen waveform data may be processed to output the alarm information to indicate the type of the transmission fault and/or the location of the transmission fault.

For example, the detection controller 113 is configured to obtain the alarm information based on the frozen waveform data and state information; the state information includes a transmission state parameter of the optical signal. In the embodiments of the present disclosure, when the detection controller 113 generates the alarm information based on the frozen waveform data, it may analyze the transmission fault based on the frozen waveform data and the state information (e.g., parameter(s) that can be obtained slowly) that does not need to be dynamically captured by the memory 112. The parameter(s) that can be obtained slowly may be used as the state information to help the generation of the alarm information. Similar to the at least one performance parameter, and the state information is also related to the transmission quality of the optical signal. In some examples, the status information includes at least one of: optical signal received power, bit error ratio (BER), bit error alarm information, signal-to-noise ratio (SNR), error vector magnitude (EVM), polarization dependent loss (PDL), differential group delay (DGD), state of polarization (SOP), signal spectrum, signal clock, fiber nonlinearity, local oscillator frequency offset (LOFO), carrier phase, automatic gain control (AGC) gain, device parameters of the data processing circuit 111, or carrier frequency. For example, the state information is the optical signal received power, and the power change curve caused by the fiber nonlinearity may be determined by the power profile estimation (PPE) based on the optical signal received power. In combination of the frozen waveform data and the power change curve, the frozen waveform data is subjected to the PPE to obtain a power change curve with the transmission fault by using the power change curve of normal operation as a reference. Based on the reference power change curve of normal operation and the power change curve with the transmission fault, the loss anomaly of the optical fiber may be localized. In this way, it may be possible to identify and localize the transmission fault of the waveform data.

In some possible implementation manners, the memory 112 is used to store time stamp information of the frozen waveform data. In the embodiments of the present disclosure, although the optical receiver 110 may record and process the optical signal received power, BER, bit error alarm information, SNR, EVM, PDL, DGD, SOP, signal spectrum, signal clock, fiber nonlinearity, LOFO, carrier phase, AGC gain, device parameters of the data processing circuit 111, carrier frequency and other parameters, the generation time, duration and recording time, etc. of different performance parameters are different. In order to ensure the processing accuracy of the frozen waveform data, the time stamp information of the frozen waveform data may be stored in the memory 112. During the subsequent processing of the frozen waveform data, the accurate occurrence time of the corresponding frozen waveform data may be determined based on the time stamp information, thus improving the processing accuracy. For example, when the frozen waveform data is sent offline to an external computing device for transmission fault analysis, the time stamp information may help the external computing device quickly and accurately determine the location of the transmission fault. As another example, when the detection controller 113 analyses the transmission fault based on the frozen waveform data and the state information to output the alarm information, since the obtaining time and duration of the state information and the frozen waveform data are different, the state information and the frozen waveform data may be uniformly aligned in time through the time stamp information. In this way, it may be possible to achieve quick analysis and processing of the transmission faults in combination of the state information and the frozen waveform data.

For example, the memory 112 is further used to record seconds long of the waveform data or the frozen waveform data. In the embodiments of the present disclosure, the time stamp information and seconds long may be combined to enhance the accuracy of time alignment of different signals.

In some possible implementation manners, the at least one state parameter includes forward error correction (FEC) BER of signal frame(s) in the waveform data. For example, the detection controller 113 is used to output the first indicating signal to the memory 112 in a case where the coding error ratio or the coding error alarm information of the data information satisfies the first condition.

In some examples, the coding correction circuit 111D performs the coding correction on the data information. If the FEC BER of the corrected data information is greater than zero, it means that the data transmission fails. At this time, the coding error alarm information may be output, which indicates that there is a failure in the data transmission. In this case, it may be determined that the FEC BER satisfies the first condition, and the first indicating signal is generated to trigger the memory 112 to freeze the waveform data. In the embodiments of the present disclosure, since the coding error alarm information is generated, which means that there is a transmission failure, the memory 112 is required to timely capture the waveform data corresponding to the relevant transmission fault.

In some examples, whether the first condition is satisfied may be determined based on a pre-FEC BER (i.e., the coding error ratio). When the pre-FEC BER of a certain signal frame is greater than a certain value, it may also be determined that the transmission quality decreases to the first degree. At this time, it is likely that the transmission failure will occur or the transmission failure has already occurred. Therefore, whether the first condition is satisfied may be determined according to the magnitude of the pre-FEC BER, and the first indicating signal is generated to trigger the memory 112 to freeze the waveform data.

In some possible implementation manners, the duration (or time span) of the waveform data is greater than the duration of at least one signal frame. In the embodiments of the present disclosure, as shown in FIG. 11, within a time range, signal frames in the data information carried on the optical signal are sequentially transmitted to the optical receiver 110. The waveform data is dynamically buffered and frozen based on known frame timing of the data information, which may make it easier to process valid waveform data. In this process, in consideration of the size of the storage space of the memory 112, the time span of the waveform data is set to be greater than the duration of at least one signal frame, so that the capacity of storing the relevant waveform data of the signal frame(s) may be ensured as much as possible. Therefore, when interleaving is adopted based on the frame timing, there may be a high burst error tolerance in the obtaining of the FEC BER.

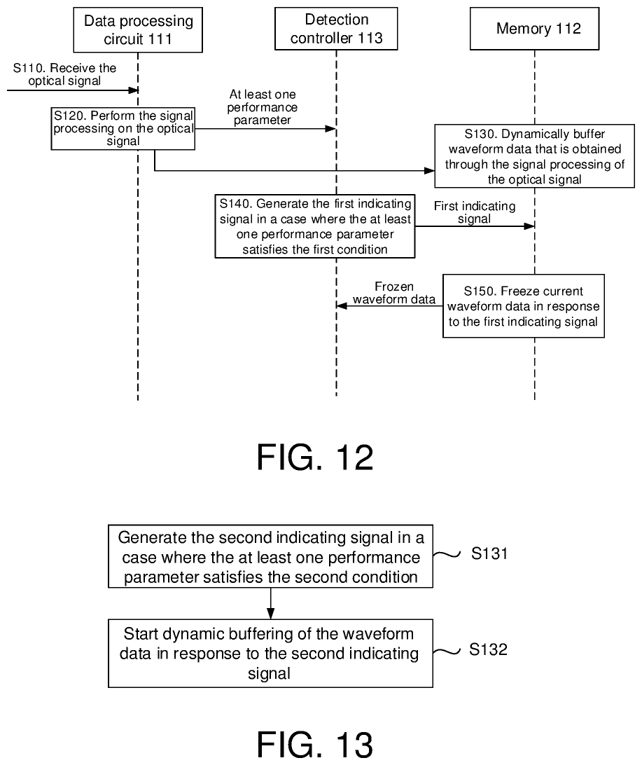

Based on the optical receiver 110 mentioned in the above embodiments shown in FIGS. 5 to 11, the optical receiver 110 can perform the signal processing method that includes the following steps S110 to S150 shown in FIG. 12.

In S110, the optical signal is received.

In the embodiments of the present disclosure, as shown in FIG. 12, the data processing circuit 111 of the optical receiver 110 receives the optical signal. The optical signal carries data information.

In S120, signal processing is performed on the optical signal.

In some examples, as shown in FIG. 12, the data processing circuit 111 of the optical receiver 110 performs the signal processing on the received optical signal to obtain the data information and at least one performance parameter; and at least one performance parameter is used to indicate the transmission quality of the optical signal.

For example, as shown in FIG. 10, one or more of the OE 111A, the ADC 111B, the DSP 111C and the coding correction circuit 111D in the data processing circuit 111 may provide some parameters to the detection controller 113 as the at least one performance parameter.

For example, as shown in FIG. 10, the DSP 111C in the data processing circuit 111 outputs data information before coding correction. The coding correction circuit 111D outputs data information after coding correction.

For example, as shown in FIG. 10, data obtained through the data processing by one or more of the ADC 111B, the DSP 111C and the coding correction circuit 111D may be dynamically buffered into the memory 112 as the waveform data.

In S130, the waveform data that is obtained through the signal processing of the optical signal is dynamically buffered.

For example, as shown in FIG. 12, the memory 112 dynamically buffers the waveform data output by the data processing circuit 111.

In some possible implementation manners, the step S130 further includes: sampling the waveform data at intervals; and dynamically buffering sampled waveform data. For example, the memory 112 may sample the waveform data, thus storing the waveform data covering a larger time span in the limited storage space.

In some possible implementation manners, the step S130 further includes storing time stamp information of the frozen waveform data. In the embodiments of the present disclosure, by storing the time stamp information of the waveform data, the accuracy of subsequent data processing of the waveform data may be improved.

In some possible implementation manners, the memory 112 may be configured to enable continuous dynamic buffering in response to a start-up operation. In this case, the memory 112 may continuously perform dynamic buffering of the waveform data without additional trigger condition.

In some possible implementation manners, the memory 112 may be configured to enable dynamic buffering in response to a certain trigger condition. For example, the memory 112 is triggered by a certain trigger signal to start dynamic buffering of the waveform data. In this case, the step S130 further includes the following sub-operations of steps S131 to S132 as shown in FIG. 13.

In S131, the second indication signal is generated in a case where the at least one performance parameter satisfies the second condition.

In the embodiments of the present disclosure, the second condition includes that the transmission quality of the optical signal decreases to the second degree. As shown in FIG. 13, in a case where the at least one performance parameter satisfies the second condition, it is determined that the transmission quality of the optical signal decreases to the second degree, and the second indicating signal is generated.

In S132, dynamic buffering of the waveform data is started in response to the second indicating signal.

In the embodiments of the present disclosure, as shown in FIG. 13, whether the at least one performance parameter satisfies the second condition is determined. When the at least one performance parameter satisfies the second condition, it means that the transmission quality of the optical signal has a downward trend and will decrease below the preset second degree. The second degree is a preset value based on the actual situation. The value of the second degree is determined according to the transmission quality that needs to be paid attention. There may be a timing when the transmission fault occurs. At this timing, the second indicating signal is generated, and the second indicating signal is used to indicate that the memory 112 starts to perform dynamic buffering operation on the waveform data. Then, when the at least one performance parameter satisfies the first condition, the dynamically buffered waveform data can be frozen. Since the read and write processing operations of the memory 112 will cause large power consumption, through the above operations of the embodiments of the present disclosure, it may ensure the hit rate of freezing the waveform data in a case where the increase in the power consumption caused by long-term dynamic buffering operation is avoided.

As for the description of the at least one performance parameter, reference may be made to the relevant descriptions in the above embodiments of the optical receiver 110, and details will not be repeated here.

In S140, the first indication signal is generated in a case where the at least one performance parameter satisfies the first condition.

In the embodiments of the present disclosure, the first condition includes at least one of the following that: the optical signal has a transmission fault; or the transmission quality of the optical signal decreases to the first degree. The second degree is greater than the first degree. That is, the transmission quality of the second degree is higher than the transmission quality of the first degree.

For example, during the process of the data processing circuit 111 performing signal processing on the received optical signal, the corresponding waveform data is obtained. The memory 112 dynamically buffers the waveform data. The at least one performance parameter includes parameter(s) related to the transmission quality of the optical signal. Based on determining whether the at least one performance parameter satisfies the first condition, it is determined whether the current waveform data that is dynamically buffered needs to be frozen to obtain the frozen waveform data. The first condition includes at least one of the following that: the optical signal has a transmission fault, or the transmission quality of the optical signal decreases to the first degree. Therefore, when the at least one performance parameter satisfies the first condition, it means that the optical signal has a transmission fault at a current time. The memory 112 dynamically buffers the waveform data for a period of time before the current time. Therefore, after the dynamically buffered waveform data is frozen, the waveform characteristic information corresponding to the transmission fault may be obtained from the frozen waveform data. In this way, the waveform data corresponding to the transient influence factors may be obtained, thereby improving the feasibility and processing accuracy of operations such as capturing, classifying, identifying, and localizing the transmission faults.

In S150, the current waveform data is frozen in response to the first indicating signal.

In the embodiments of the present disclosure, the memory 112 freezes the current waveform data in response to the first indicating signal to obtain the frozen waveform data. The frozen waveform data includes waveform characteristic information of the transmission fault. Through the signal processing method described in FIGS. 12 and 13, the waveform data corresponding to the transient influence factors can be captured.

In some possible implementation manners, the frozen waveform data in the memory 112 may be output to an external computing device. The external computing device uses corresponding algorithms to detect, classify, and localize the transmission fault based on the frozen waveform data.

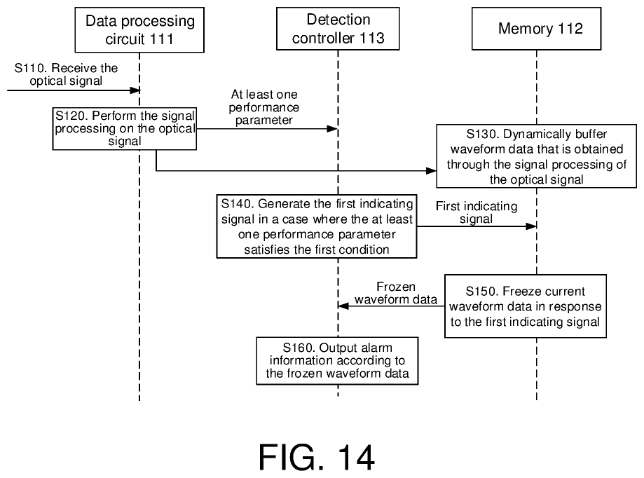

In some possible implementation manners, the transmission fault may be detected and localized through the optical receiver 110. In this case, as shown in FIG. 14, the signal processing method further includes step S160.

In S160, the alarm information is output according to the frozen waveform data.

For example, the alarm information is used to indicate a type of the transmission fault and/or a location of the transmission fault. In the embodiments of the present disclosure, when the detection controller 113 obtains the frozen waveform data, the detection controller 113 may process the frozen waveform data to output the alarm information to indicate the type of the transmission fault and/or the location of the transmission fault.

In some examples, step S160 may include: outputting the alarm information according to the frozen waveform data and state information, the state information includes a transmission state parameter of the optical signal. In the embodiments of the present disclosure, when the detection controller 113 generates the alarm information based on the frozen waveform data, it may analyze the transmission fault based on the frozen waveform data and the state information (e.g., parameter(s) that can be obtained slowly) that does not need to be dynamically captured by the memory 112. The parameter(s) that can be obtained slowly may be used as the state information to help the generation of the alarm information. The state information is similar to the at least one performance parameter, and is related to the transmission quality of the optical signal. In some examples, the status information includes at least one of: optical signal received power, bit error ratio (BER), bit error alarm information, signal-to-noise ratio (SNR), error vector magnitude (EVM), polarization dependent loss (PDL), differential group delay (DGD), state of polarization (SOP), signal spectrum, signal clock, fiber nonlinearity, local oscillator frequency offset (LOFO), carrier phase, automatic gain control (AGC) gain, device parameters of the data processing circuit 111, or carrier frequency. For example, the state information is the optical signal received power, and the power change curve caused by the fiber nonlinearity may be determined by the power profile estimation (PPE) based on the optical signal received power. In combination of the frozen waveform data and the power change curve, the frozen waveform data is subjected to the PPE to obtain a power change curve with the transmission fault by using the power change curve of normal operation as a reference. Based on the reference power change curve of normal operation and the power change curve with the transmission fault, the loss anomaly of the optical fiber may be localized. In this way, it may be possible to identify and localize the transmission fault of the waveform data.

The embodiments of the present disclosure provide the optical receiver and the signal processing method. The optical receiver is used to perform the signal processing method. The optical receiver is provided therein with the data processing circuit and the memory. The data processing circuit is used to receive the optical signal carrying the data information and perform the signal processing on the optical signal to obtain the data information and the at least one performance parameter. The at least one performance parameter is used to indicate the transmission quality of the optical signal. When the data processing circuit performs the signal processing on the optical signal, the waveform data through the signal processing process will be obtained. The memory is used to dynamically buffer the waveform data. When the at least one performance parameter satisfies the first condition, it means that the transmission fault exists in the optical signal and/or the transmission quality of the optical signal decreases to the first degree. At this time, the first indicating signal may be generated. The memory is further used to freeze the current waveform data in response to the first indicating signal to obtain the frozen waveform data. The frozen waveform data includes the waveform characteristic information of the transmission fault. Through the above operations, the embodiments of the present disclosure can obtain the waveform data corresponding to the transient influence factors, so that the transmission faults may be well analyzed.

Some embodiments of the present disclosure provide a computer-readable storage medium (e.g., a non-transitory computer-readable storage medium). The computer-readable storage medium has stored thereon computer program instructions that, when executed by a computer (i.e., a computing device), cause the computer to perform one or more steps in the signal processing method as described in any of the above embodiments.

For example, the computer-readable storage medium includes, but is not limited to, a magnetic storage device (e.g., a hard disk, a floppy disk or a magnetic tape), an optical disk (e.g., a compact disk (CD), or a DVD), a smart card, and a flash memory device (e.g., an erasable programmable read-only memory (EPROM), a card, a stick or a key driver). Various computer-readable storage media described in the embodiments of the present disclosure may represent one or more devices and/or other machine-readable storage media, which are used for storing information. The term “computer-readable storage medium” may include, but is not limited to, wireless channels and various other media capable of storing, containing and/or carrying instructions and/or data.

Some embodiments of the present disclosure further provide a computer program product. The computer program product includes computer program instructions carried on a non-transitory computer-readable storage medium. When executed by a computer, the computer program instructions cause the computer to perform one or more steps of the signal processing method as described in any of the above embodiments.

Beneficial effects of the computer-readable storage medium and the computer program product are the same as the beneficial effects of the signal processing method as described in the above embodiments, which will not be repeated here.

The processor or controller involved in the embodiments of the present disclosure may be a chip, such as a field programmable gate array (FPGA), an application specific integrated circuit (ASIC), a system on chip (SoC), a central processing unit (CPU), a network processor (NP), a DSP, or a microcontroller unit (MCU), a programmable logic device (PLD) or other integrated chip.

The memory involved in the embodiments of the present disclosure may be a volatile memory or a non-volatile memory, or may include both volatile and non-volatile memories. The non-volatile memory may be a read-only memory (ROM), a programmable ROM (PROM), an erasable programmable read-only memory (EPROM), an electrically EPROM (EEPROM) or a flash memory. The volatile memory may be a random access memory (RAM), which acts as an external cache. By way of illustration, but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM)) and a direct rambus RAM (DR RAM). It should be noted that the memory described herein is intended to include, but is not limited to, these and any other suitable types of memory.

It should be understood that in the embodiments of the present disclosure, the size of the sequence numbers of the above-mentioned processes does not mean the order of execution. The execution order of the processes should be determined by their functions and internal logic, and should not limit the implementation processes in the embodiments of the present disclosure.

Those skilled in the art can realize that by combining modules and algorithm steps of the examples described in the embodiments of the present disclosure, the embodiments of the present disclosure can be implemented through electronic hardware or a combination of electronic hardware and computer software. Whether the functions are performed through the hardware or software depends on the specific application and restrictive conditions on design of the technical solution. Those skilled in the art may use different methods for each specific application to implement the described functions, but such implementation should not be considered beyond the scope of the present disclosure.

Those skilled in the art can clearly understand that for the convenience and simplicity of description, the specific working processes of the method described above can be referred to the corresponding processes in the foregoing device embodiments, and details will not be repeated here.

In several embodiments provided in the present disclosure, it will be understood that the disclosed systems, devices and methods may be implemented through other manners. For example, the device embodiments described above are merely exemplary. For example, the division of the functional modules or units is only a logical functional division. In actual implementation, there may be other division manners. For example, in some embodiments, a plurality of devices or components may be combined or integrated into another system, or some features may be ignored or not executed. In addition, the mutual coupling or direct coupling or communication connection shown or discussed may be an indirect coupling or communication connection through some interfaces, devices or modules, and may be an electrical connection, a mechanical connection or other forms of connections.

The modules or units described as separate components may or may not be physically separated, and the components shown as modules may or may not be physical modules. That is, they may be located in one place, or may be distributed to multiple network modules. Some or all of the modules may be selected according to actual needs to achieve the purposes of the solutions in the embodiments.

The functional modules in the embodiments of the present disclosure may be integrated into a single device; or, the modules may be separate physical modules; or, two or more modules may be integrated into a single device.

The above embodiments may be implemented in whole or in part through software, hardware, firmware, or any combination thereof. In a case where the above embodiments are implemented by using a software program, the software program may be implemented in whole or in part in a form of a computer program product. The computer program product includes one or more computer instructions. When loaded and executed on a computer, the computer instructions generate some of all of the processes or functions provided in the embodiments of the present disclosure. The computer may be a general-purpose computer, a dedicated computer, a computer network, or any other programmable device. The computer instructions may be stored in a computer-readable storage medium, or transmitted from one computer-readable storage medium to another computer-readable storage medium. For example, The computer instructions may be transmitted from one website site, computer, server or data center to another website site, computer, server or data center through wired (e.g., coaxial cable, optical fiber, digital subscriber line (DSL)) or wireless (e.g., infrared, wireless, microwave) methods. The computer-readable storage medium may be any available medium that may be accessed by the computer, or a server, a data center or any other data storage device including one or more available media. The available medium may be a magnetic medium (e.g., a floppy disk, a magnetic disk or a magnetic tape), an optical medium (e.g., a digital versatile disk (DVD)), a semiconductor medium (e.g., a solid state drive (SSD)), or the like.

The foregoing descriptions are merely specific implementations of the present disclosure, but the protection scope of the present disclosure is not limited thereto. Any changes or replacements within the technical scope of the present disclosure shall be included in the protection scope of the present disclosure. Therefore, the protection scope of the present disclosure shall be subject to the protection scope of the claims.

What is claimed is:

1. An optical receiver, comprising:
a data processing circuit used to receive an optical signal carrying data information and perform a signal processing on the optical signal to obtain the data information and at least one performance parameter, the at least one performance parameter being used to indicate a transmission quality of the optical signal;
a memory used to dynamically buffer waveform data that is obtained through the signal processing of the optical signal by the data processing circuit; and
a detection controller used to output a first indicating signal to the memory in a case where the at least one performance parameter satisfies a first condition, wherein the first condition includes at least one of that the optical signal has a transmission fault or the transmission quality of the optical signal decreases to a first degree;
wherein the memory is further used to freeze current waveform data to obtain frozen waveform data in response to the first indicating signal, and the frozen waveform data includes waveform characteristic information of the transmission fault.

2. The optical receiver according to claim 1, wherein the detection controller is further used to output a second indicating signal in a case where the at least one performance parameter satisfies a second condition, wherein the second condition includes that the transmission quality of the optical signal decreases to a second degree, the transmission quality of the second degree being higher than the transmission quality of the first degree; and
the memory is further used to start dynamic buffering of the waveform data in response to the second indicating signal.

3. The optical receiver according to claim 1, wherein the detection controller is further used to output alarm information according to the frozen waveform data, wherein the alarm information is used to indicate a type of the transmission fault and/or a location of the transmission fault.

4. The optical receiver according to claim 3, wherein the detection controller is used to output the alarm information according to the frozen waveform data and state information, wherein the state information includes a transmission state parameter of the optical signal.

5. The optical receiver according to claim 4, wherein the state information includes at least one of: optical signal received power, bit error rate (BER), bit error alarm information, signal-to-noise ratio (SNR), error vector magnitude (EVM), polarization dependent loss (PDL), differential group delay (DGD), state of polarization (SOP), signal spectrum, signal clock, fiber nonlinearity, local oscillator frequency offset (LOFO), carrier phase, automatic gain control (AGC) gain, device parameters of the data processing circuit, or carrier frequency.

6. The optical receiver according to claim 1, wherein the memory is used to sample the waveform data at intervals and dynamically buffer the sampled waveform data.

7. The optical receiver according to claim 1, wherein the memory is used to store time stamp information of the frozen waveform data.

8. The optical receiver according to claim 1, wherein the first condition includes at least one of a signal trigger condition, a static threshold condition, or a dynamic threshold condition.

9. The optical receiver according to claim 1, wherein the at least one performance parameter includes at least one of: optical signal received power, bit error ratio (BER), bit error alarm information, signal-to-noise ratio (SNR), error vector magnitude (EVM), polarization dependent loss (PDL), differential group delay (DGD), state of polarization (SOP), signal spectrum, signal clock, fiber nonlinearity, local oscillator frequency offset (LOFO), carrier phase, automatic gain control (AGC) gain, device parameters of the data processing circuit, or carrier frequency.

10. The optical receiver according to claim 9, wherein the data processing circuit includes a coding correction circuit used to perform a coding error correction on the data information; and
the detection controller is used to output the first indicating signal to the memory in a case where a coding error ratio or coding error alarm information of the data information satisfies the first condition.

11. The optical receiver according to claim 10, wherein a duration of the waveform data is greater than a duration of at least one signal frame.

12. A signal processing method, performed by an optical receiver, the signal processing method comprising:
receiving an optical signal carrying data information;
performing a signal processing on the optical signal to obtain the data information and at least one performance parameter, the at least one performance parameter being used to indicate a transmission quality of the optical signal;
dynamically buffering waveform data that is obtained through the signal processing of the optical signal;
generating a first indicating signal in a case where the at least one performance parameter satisfies a first condition, wherein the first condition includes at least one of that: the optical signal has a transmission fault or the transmission quality of the optical signal decreases to a first degree; and
freezing current waveform data to obtain frozen waveform data in response to the first indicating signal, wherein the frozen waveform data includes waveform characteristic information of the transmission fault.

13. The signal processing method according to claim 12, further comprising:
generating a second indicating signal in a case where the at least one performance parameter satisfies a second condition, wherein the second condition includes that the transmission quality of the optical signal decreases to a second degree, and the transmission quality of the second degree being higher than the transmission quality of the first degree; and the second indicating signal is used to indicate a start of dynamic buffering of the waveform data.

14. The signal processing method according to claim 12, further comprising:
outputting alarm information according to the frozen waveform data, wherein the alarm information is used to indicate a type of the transmission fault and/or a location of the transmission fault.

15. The signal processing method according to claim 14, wherein outputting the alarm information according to the frozen waveform data includes:
outputting the alarm information according to the frozen waveform data and state information, wherein the state information includes a transmission state parameter of the optical signal.

16. The signal processing method according to claim 12, wherein dynamically buffering the waveform data that is obtained through the signal processing of the optical signal includes:
sampling the waveform data at intervals; and
dynamically buffering the sampled waveform data.

17. The signal processing method according to claim 12, wherein dynamically buffering the waveform data that is obtained through the signal processing of the optical signal includes:
storing time stamp information of the frozen waveform data.

18. The signal processing method according to claim 12, wherein the at least one performance parameter includes at least one of: optical signal received power, bit error ratio (BER), bit error alarm information, signal-to-noise ratio (SNR), error vector magnitude (EVM), polarization dependent loss (PDL), differential group delay (DGD), state of polarization (SOP), signal spectrum, signal clock, fiber nonlinearity, local oscillator frequency offset (LOFO), carrier phase, automatic gain control (AGC) gain, device parameters of a data processing circuit of the optical receiver, or carrier frequency.

19. The signal processing method according to claim 18, wherein generating the first indicating signal includes:
performing a coding error correction on the data information; and
generating the first indicating signal in a case where a coding error ratio or coding error alarm information of the data information satisfies the first condition.

20. A non-transitory computer-readable storage medium having stored thereon computer program instructions that, when executed by a computer, cause the computer to perform the signal processing method according to claim 12.
